(19) United States
(12) Patent Application Publication
(10) Pub. No.: US 2009/0046823 A1
(43) Pub. Date: Feb. 19, 2009

(54) NEUTRON GENERATING DEVICE

(75) Inventors: Henry Litzmann Edwards, Garland, TX (US); Tathagata Chatterjee, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/838,674

(22) Filed: Aug. 14, 2007

(51) Int. Cl. H05H 3/06

(52) U.S. Cl. 376/114

(57) ABSTRACT

A neutron generating device is described. In one embodiment, the device has a chamber filled with a gas containing deuterium or tritium together with a piezoelectric crystal having a mechanical excitation apparatus proximate thereto. The piezoelectric crystal has first and second metal electrodes located on opposing surfaces. The first metal electrode is in electrical contact with a neutral potential. A field emitter tip is located on the second metal electrode, which emits an electrical field to form deuterium or tritium ions upon the mechanical excitation of the piezoelectric crystal. The deuterium or tritium ions are accelerated by an electric potential differential between the first metal electrode and the second metal electrode into a target containing deuterium or tritium with sufficient energy to form neutrons.

### TECHNICAL FIELD OF THE INVENTION

The disclosure is directed, in general, to a neutron generating device and, more specifically, to a piezoelectric crystal device that accelerates a deuterium or tritium ion with sufficient energy to impact a deuterium or tritium target to form a neutron.

### BACKGROUND OF THE INVENTION

There are a number of commercial and scientific applications where neutrons are generated and used for analyses and measurement applications. For example, a neutron beam can be used to generate a picture of the inside of an object in a manner similar to the way an x-ray pictures the inside of a person's body. While x-rays are absorbed or reflected by heavy elements and transparent to lighter elements, neutrons are absorbed or reflected by light elements and transparent to heavier elements. This feature can be used to analyze such functions as fluid flowing in a pipe and the flow of fuel in an engine. Neutrons can also be used in the mapping of three dimensional stresses within polycrystalline materials. Thus, neutrons can be used to measure polycrystalline material texture; analyze films and surfaces of materials; perform measurement functions in realistic conditions of temperature, pressure, strain, etc.; and to probe most types of materials, including metals, polymers, biological tissue, glass, minerals etc.

A promising use of neutron technology in the global war against terrorism is for nondestructive inspection. Such technology can be used in the inspection of luggage, cargo containers, vehicles and so forth. Of course other applications for the technology exist in such diverse fields as medicine, energy generation, and propulsion.

A major limitation on the use of neutron technology is the fact that most prior art neutron sources are bulky and expensive. Accordingly, what is needed in the art is a neutron source that does not have these drawbacks.

### SUMMARY OF THE INVENTION

To address the above-discussed deficiencies of the prior art, a neutron generating device is described herein. In one embodiment, the device provides for a chamber filled with a gas containing deuterium or tritium together with a piezoelectric crystal having a mechanical excitation apparatus proximate thereto. Located on opposing surfaces of the piezoelectric crystal are first and second metal electrodes. The first metal electrode is in electrical contact with a neutral potential. A field emitter tip is located in contact with the second metal electrode and emits an electrical field to form deuterium or tritium ions when the piezoelectric crystal is subjected to mechanical excitation. The deuterium or tritium ions are then accelerated by the electric potential differential between the first electrode and the second electrode into a target containing deuterium or tritium with sufficient energy to form neutrons.

Another embodiment provides for a chamber containing a deuterated or tritiated liquid. A mechanical excitation apparatus located proximate the chamber forms pressure waves in the liquid. Located at an approximate center of the chamber is a piezoelectric crystal with metal electrodes located on opposing surfaces thereof. The metal electrodes develop an electrical field when the piezoelectric crystal is excited by the convergence of pressure waves at the approximate center of the chamber. The resultant electrical field forms deuterium or tritium ions that are accelerated by an electric potential differential between the electrodes into a target containing deuterium or tritium with sufficient energy to form neutrons.

In still another embodiment, a piezoelectric crystal has a source of deuterium or tritium ions and a mechanical excitation apparatus proximate thereto. Upon a mechanical excitation of the piezoelectric crystal, electrodes located in contact with a surface of the piezoelectric crystal form an electrical field. Sufficient electric potential differential is generated between the electrodes to accelerate the deuterium or tritium ions into a target containing deuterium or tritium with sufficient energy to form neutrons.

A method of generating neutrons is also provided for herein. In one embodiment, the method includes providing a piezoelectric crystal that has metal electrodes on its surface proximate to a source of deuterium or tritium ions. A mechanical excitation apparatus is then caused to excite the piezoelectric crystal and form an electrical field. Sufficient electric potential differential is generated to accelerate the deuterium or tritium ions into a target containing deuterium or tritium with sufficient energy to form neutrons.

### BRIEF DESCRIPTION OF THE DRAWINGS

For a more complete understanding of the disclosure, reference is now made to the following descriptions taken in conjunction with the accompanying drawings, in which:

FIG. 1 illustrates a schematic of an embodiment of a neutron generating device that has a piezoelectric crystal located within a chamber filled with a gas;

FIGS. 2A-2C illustrate representations of various applications utilizing a striking force as a mechanical excitation apparatus to excite the piezoelectric crystal;

FIGS. 3A-3B illustrate an embodiment of a neutron generating device where a piezoelectric crystal is located within a chamber containing a deuterated or tritiated liquid;

FIG. 4 illustrates an embodiment of a neutron generating device where a piezoelectric crystal utilizes a proximate source of deuterium or tritium ions embedded in an electrode; and

FIG. 5 illustrates a method of generating neutrons.

### DETAILED DESCRIPTION

It has recently been demonstrated that neutrons can be generated at near room temperature with a compact device using a pyroelectric crystal. When heated, the pyroelectric crystal produces an electric field capable of accelerating deuterium atoms into a deuterium target with sufficient energy to produce neutrons. A pyroelectric crystal may not be the best source for generating neutrons because heating and cooling of the material requires a great deal of energy. This means the generation of neutrons with such a device is difficult to accomplish quickly and on a repetitive basis. Accordingly, it has been observed that a piezoelectric crystal, as opposed to pyroelectric crystal, might be used to generate neutrons.

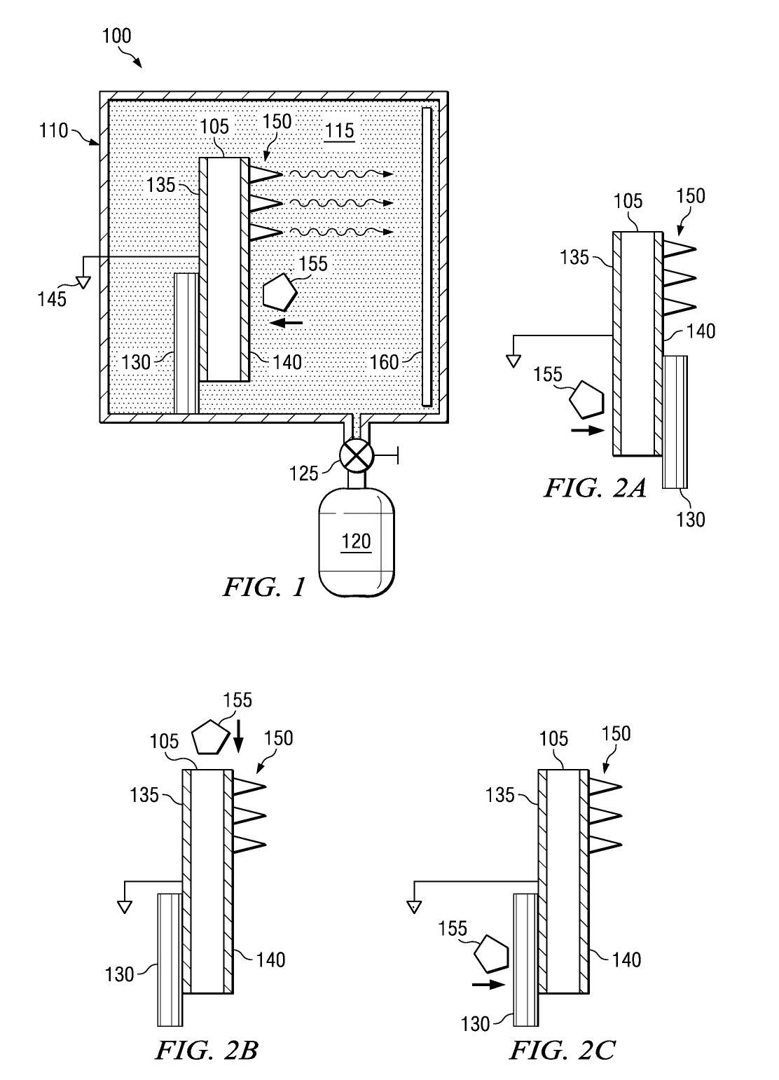

FIG. 1 illustrates a schematic of an embodiment of a neutron generating device 100 that has a piezoelectric crystal 105 located within a chamber 110 filled with a gas 115. The chamber 110 may be a variable pressure or vacuum chamber into which gas 115 containing deuterium or tritium is introduced from a gas source 120. As will be familiar to those skilled in the pertinent art, a metering apparatus 125 may be used to control the gas 115 admitted into the chamber 110.

A support 130, located within the chamber 110, is configured to hold the piezoelectric crystal 105. Located on opposing surfaces of the piezoelectric crystal 105 are a first metal electrode 135 and a second metal electrode 140. The first and second electrodes 135, 140 may each include one or more conductive layers. The first metal electrode 135 is, in one embodiment, in electrical contact with a neutral potential 145. Located on the second metal electrode 140 are a plurality of field emitter tips 150. In one embodiment, the second metal electrode 140 will have a single field emitter tip 150 while in other embodiments there may be a plurality of field emitter tips 150.

Proximate the piezoelectric crystal 105 is a mechanical excitation apparatus 155. Illustrated schematically is a striking apparatus to excite the piezoelectric crystal 105 by directly applying mechanical force to the crystal 105. However, other types of a mechanical excitation apparatus 155 can also be used to apply mechanical force to the piezoelectric crystal 105. For example, the mechanical excitation apparatus, in one embodiment, may be a laser apparatus providing mechanical excitation by laser pulses.

When the piezoelectric crystal 105 is excited by the application of mechanical strain, it develops an internal electrical field. This causes an electrical potential differential to develop between the first metal electrode 135 and the second metal electrode 140. The field emitter tips 150 on the second metal electrode 140 emit an electrical field that ionizes the deuterium or tritium in the gas 115 to form deuterium or tritium ions. The deuterium or tritium ions are then accelerated, for example by the electrical potential differential between the first metal electrode 135 and the second metal electrode 140, into a target 160 containing deuterium or tritium. The deuterium or tritium ions are accelerated into the target 160 with sufficient energy to form neutrons.

Turning now to FIGS. 2A-2C, illustrated are representations of various applications utilizing a striking force as a mechanical excitation apparatus 155 for exciting the piezoelectric crystal 105. This illustrates that the piezoelectric crystal 105 can have a mechanical force exerted on it in a number of different ways to cause the required excitation. As illustrated in FIG. 1, the mechanical excitation apparatus 155 can apply mechanical force to the second metal electrode 140 which, because it is in contact with the piezoelectric crystal 105, excites the crystal 105. In FIG. 2A mechanical force is applied to the first metal electrode 135; in FIG. 2B the mechanical force is applied directly to the piezoelectric crystal 105; and in FIG. 2C the mechanical force is applied to the piezoelectric crystal 135 support 130. FIG. 1 as well as FIGS. 2A-2C illustrate various possible embodiments where a mechanical excitation apparatus 155 is proximate the piezoelectric crystal 105. As illustrated, the striking apparatus 155 excites the crystal 105, although it may not be in direct contact therewith.

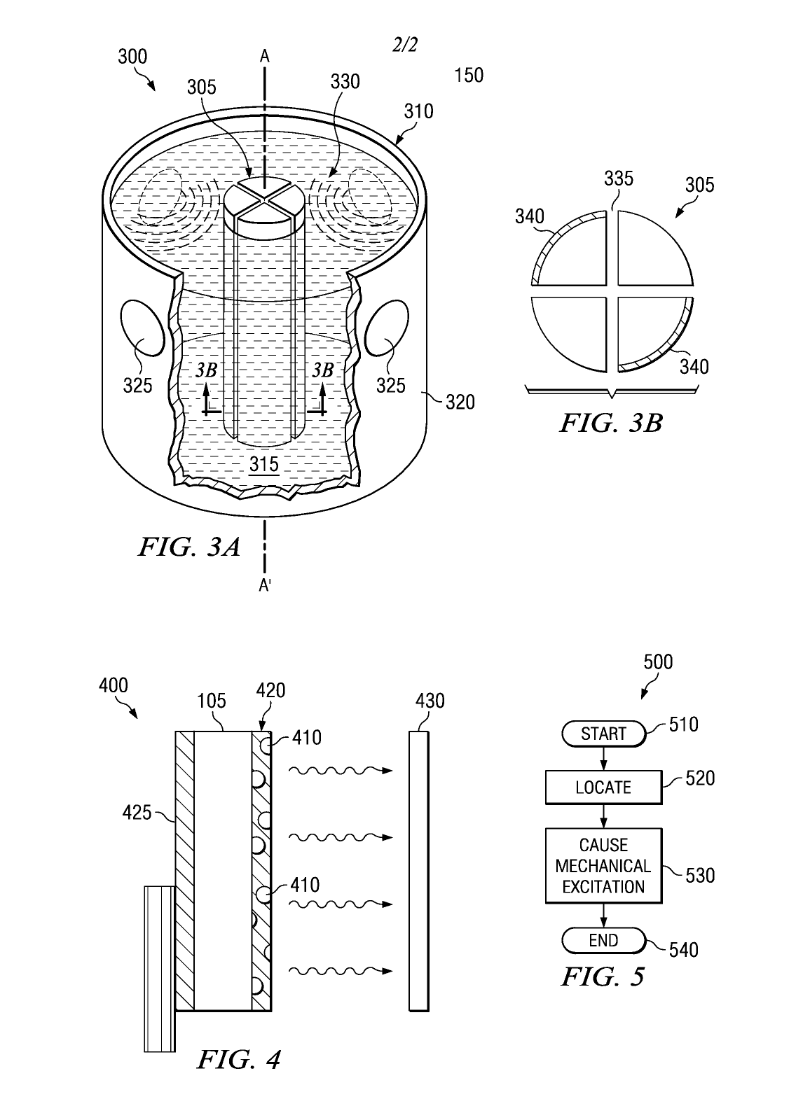

Turning now to FIGS. 3A and 3B, an embodiment of a neutron generating device 300 is illustrated where a piezoelectric crystal 305 is located in a chamber 310 containing a deuterated or tritiated liquid 315. The chamber 310 has a cylindrical shape, although other embodiments provide for different shapes (e.g., spherical, regular hexahedron, cuboid, etc). Although an embodiment provides for the deuterated or tritiated liquid 315 to be heavy water or deuterated ethanol, other organic liquids may also be used in which deuterium or tritium replaces hydrogen in the structure. Deuterium, with a chemical symbol of D, has one proton and one neutron in its neucleus. Deuterium is a heavier isotope of hydrogen, with the chemical symbol of H, which has a single proton in its nucleus. The term “heavy water” refers to water in which the hydrogen has been displaced by deuterium and is denoted by the chemical formula of D₂O. Deuterated ethanol also has the hydrogen atoms replaced with deuterium and is denoted by the chemical formula C₂D₅OD. On an outside surface 320 of the chamber 310, a mechanical excitation apparatus 325 is located to cause pressure waves 330 to form in the fluid 315. At an approximate center A-A′ of the chamber 310, is located the piezoelectric crystal 305.

FIG. 3B shows a cross-sectional view B-B′ of the piezoelectric crystal 305. The crystal 305 of FIG. 3B has channels 335 or cavities filled with the deuterated or tritiated liquid 315. In contact with opposing surfaces of the piezoelectric crystal 305 are metal electrodes 340 that develop an electrical field when the piezoelectric crystal 305 is excited. The piezoelectric crystal 305 is excited by the pressure waves 330 converging at the approximate center A-A′ of the chamber 310. An electrical field forms and deuterium or tritium ions are created. These ions are then accelerated by the electric potential differential between the electrodes 340 into a deuterium or tritium target with sufficient energy to form neutrons. The target, in this embodiment, constitutes the deuterated or tritiated liquid 315 in the chamber 310.

Turning now to FIG. 4, illustrated is an embodiment of a neutron generating device 400 utilizing a piezoelectric crystal 105 where the proximate source of deuterium or tritium ions is from deuterium or tritium 410 embedded in an electrode 420. Instead of being derived from embedded deuterium or tritium, as illustrated, the deuterium or tritium ions could also be impregnated in the piezoelectric crystal 105, for example by diffusion while it is being fabricated or grown. In other embodiments, the deuterium or tritium ion source can be a deuterium or tritium containing gas or liquid located in cavities in the piezoelectric crystal 105, similar to the cavities illustrated in FIG. 3B.

In the illustrated embodiment, the electrode 420 material can be palladium, which readily absorbs deuterium or tritium 410. When deuterium 410 is embedded in a palladium electrode 420, the electrode 420 serves as a reservoir for the deuterium ions. On a surface opposite the palladium electrode 420 a second electrode 425 is located.

Proximate the piezoelectric crystal 105 is a mechanical excitation apparatus (not shown). This excitation apparatus can be a striking apparatus, such as that depicted in FIG. 1 and FIGS. 2A-2C, or it can be a number of other devices. For example, the mechanical excitation apparatus can be a laser where mechanical excitation is provided by laser pulses. The mechanical excitation apparatus can also be designed to include the shape of the piezoelectric crystal 410 and electrodes 420 in concentrating the strain necessary to develop the requisite electrical field. For example, when electrodes 420 are patterned on the surface of the piezoelectric crystal 105, they can be patterned in a variety of geometric shapes to focus mechanical deformation into a certain region of the piezoelectric crystal 410. The same geometry as that used for a quartz tuning fork can be used, for example, where the tines of the fork initiate the vibration and the base receives maximum strain. Thus, the base of a piezoelectric crystal 105 with a tuning fork type of geometry can develop the high electric fields necessary to accelerate deuterium or tritium ions to form neutrons. There are, of course, other geometries known to those skilled in the pertinent art that may be used to concentrate strain at a particular location or series of locations in a similar manner.

In FIG. 4, upon mechanical excitation of the piezoelectric crystal 105, the electrodes 420, 425 form an electrical field that has sufficient electric potential differential to accelerate the deuterium or tritium ions into a target 430 containing deuterium or tritium with sufficient energy to form neutrons.

Turning now to FIG. 5, illustrated is a method 500 of generating neutrons. The method commences with a start step 510. In a providing step 520, a piezoelectric crystal having metal electrodes located on its surface is located proximate a source of deuterium or tritium ions. The term “providing”, in this context, means that the feature may be obtained from a party having already manufactured the feature, or alternatively may mean manufacturing the feature themselves and providing it for its intended purpose. The source of deuterium or tritium ions can be from the piezoelectric crystal itself if it has been impregnated with such ions or it could be from a gas or liquid containing deuterium or tritium proximate to the crystal. In some embodiments the gas or liquid containing deuterium or tritium may be located in cavities in the piezoelectric crystal.

In a causing mechanical excitation step 530, a mechanical excitation apparatus is caused to excite the piezoelectric crystal and form an electrical field with sufficient electric potential differential to accelerate the deuterium or tritium ions into a target containing deuterium or tritium. See Naranjo, Gimzewski and Putterman, Observation of Nuclear Fusion Driven by a Pyroelectric Crystal, 434 NATURE 1115 (Apr. 28, 2005), incorporated herein by this reference, for a discussion of fusion with a “deuteron beam.” Based on the reported observations contained therein, the voltage developed across the piezoelectric crystal may have to be greater than about 100 kV. The ions are accelerated with sufficient energy to form neutrons. A useful method to provide the required mechanical excitation of the piezoelectric crystal is with a striking apparatus. The method concludes with an end step 540.

Those skilled in the art to which the disclosure relates will appreciate that other and further additions, deletions, substitutions and modifications may be made to the described embodiments without departing from the scope of the disclosure.

What is claimed is:

1. A neutron generating device, comprising:
a chamber filled with a gas containing deuterium or tritium;
a piezoelectric crystal having a mechanical excitation apparatus proximate thereto located in said chamber;
first and second metal electrodes located on opposing surfaces of said piezoelectric crystal, said first metal electrode in electrical contact with a neutral potential; and
a field emitter tip located in contact with said second metal electrode that emits an electrical field to form deuterium or tritium ions upon the mechanical excitation of said piezoelectric crystal, said deuterium or tritium ions accelerated by an electric potential differential between said first electrode and said second electrode into a target containing deuterium or tritium with sufficient energy to form neutrons.

2. The device as recited in claim 1 wherein said mechanical excitation is provided by a striking apparatus.

3. The device as recited in claim 1 further including a plurality of field emitter tips.

4. A neutron generating device, comprising:
a chamber containing a deuterated or tritiated liquid, said chamber having a mechanical excitation apparatus to form pressure waves in said fluid;
a piezoelectric crystal located at an approximate center of said chamber; and
metal electrodes on opposing surfaces of said piezoelectric crystal that develop an electrical field upon the excitation of said piezoelectric crystal by said pressure waves converging at said approximate center, said electrical field forming deuterium or tritium ions that are accelerated by an electric potential differential between said electrodes into a target containing deuterium or tritium with sufficient energy to form neutrons.

5. The device as recited in claim 4 wherein said liquid is heavy water or deuterated ethanol.

6. The device as recited in claim 4 wherein said chamber is spherical or cylindrical.

7. The device as recited in claim 4 wherein the target is the deuterated or tritiated liquid.

8. The device as recited in claim 4 wherein said piezoelectric crystal has cavities containing said deuterated or tritiated liquid.

9. A neutron generating device, comprising:
a piezoelectric crystal having a source of deuterium or tritium ions proximate thereto;
a mechanical excitation apparatus proximate said piezoelectric crystal; and
electrodes located in contact with a surface of said piezoelectric crystal that, upon the mechanical excitation of said piezoelectric crystal, form an electrical field having sufficient electric potential differential to accelerate said deuterium or tritium ions into a target containing deuterium or tritium with sufficient energy to form neutrons.

10. The device as recited in claim 9 wherein said piezoelectric crystal is impregnated with deuterium or tritium ions.

11. The device as recited in claim 9 wherein said piezoelectric crystal has cavities filed with a gas or a liquid containing deuterium or tritium.

12. The device as recited in claim 9 further including a material that readily absorbs deuterium or tritium, said material proximate said piezoelectric crystal and serving as a reservoir of deuterium or tritium ions.

13. The device as recited in claim 12 wherein said material is an electrode.

14. The device as recited in claim 9 wherein said piezoelectric crystal is formed to focus mechanical deformations at a certain region on said piezoelectric crystal.

15. The device as recited in claim 9 wherein said mechanical excitation is provided by a laser pulse.

16. The device as recited in claim 9 wherein said mechanical excitation is provided by a striking apparatus.

17. A method of generating neutrons, comprising:
providing a piezoelectric crystal having metal electrodes located on its surface proximate a source of deuterium or tritium ions; and
causing a mechanical excitation apparatus to excite said piezoelectric crystal and form an electrical field having sufficient electric potential differential to accelerate said deuterium or tritium ions into a target containing deuterium or tritium with sufficient energy to form neutrons.

18. The method as recited in claim 17 wherein said piezoelectric crystal is impregnated with deuterium or tritium ions.

19. The method as recited in claim 17 wherein said piezoelectric crystal has cavities filed with a gas or a liquid containing deuterium or tritium.

20. The method as recited in claim 17 wherein said source of deuterium or tritium ions is a gas containing deuterium or tritium.

21. The method as recited in claim 17 wherein said mechanical excitation is provided by a striking apparatus.
